(19) United States
(12) Patent Application Publication
(10) Pub. No.: US 2009/0267958 A1
(43) Pub. Date: Oct. 29, 2009

(54) IMAGE VIEWING USING MULTIPLE INDIVIDUAL SETTINGS

(75) Inventors: Wilhelmus Hendrikus Alfonsus Bruls, Eindhoven (NL); Bart Gerard Bernard Barenbrug, Eindhoven (NL); Dirk Kornelis Gerhardus De Boer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,541

(22) PCT Filed: Sep. 18, 2007
(86) PCT No.: PCT/IB2007/053766

§ 371 Date: Mar. 17, 2009

(30) Foreign Application Priority Data
Sep. 19, 2006 (EP) 06120896.3

(51) Int. Cl. G09G 5/00; G09G 3/00

(52) U.S. Cl. 345/581; 345/32

(57) ABSTRACT

A method of displaying an image having at least two different image settings comprises the steps of providing at least three different partial images, and displaying the at least three partial images. A first and second pair of partial images constitute the image having a first image setting and the same image having a second image setting respectively, such that the image having both image settings is visible. The partial images may be displayed either simultaneously or consecutively. The settings may comprise contrast, brightness and/or depth settings.

### FIELD OF THE INVENTION

The present invention relates to image viewing using multiple individual settings. More in particular, the present invention relates to a method of and a device for allowing two or more viewers to view the same (still and/or moving) images on the same display screen while providing one or more individual settings for each viewer. These settings may include, but are not limited to, depth, contrast, and/or brightness, and define reproduction properties of an image.

### BACKGROUND OF THE INVENTION

It is well known to display an image, or a sequence of images (such as video), using different settings (that is, adjustments or tunings). Conventional television apparatus, for example, are capable of displaying an image while allowing a user to change the settings, such as contrast, color (saturation), and brightness. However, while a certain adjustment may be appropriate for one viewer, it may be undesired or even unsuitable for another viewer. As preferences and ages of viewers may vary, typically a compromise has to be reached when viewers share a common display. However, such a compromise setting may be less than ideal for most viewers.

In the case three-dimensional images, it has been found that some viewers are particularly sensitive to the depth of the image and may even experience nausea when the three-dimensional effect is too strong, while other viewers enjoy the three-dimensional image without experiencing any side effects. Accordingly, a compromise depth setting of the shared image may cause several viewers to be discontented.

United States Patent Application US 2005/0195330 discloses a display system in which several viewers can each view an individual image: a separate channel of image content is obtained for each viewer, and a combination image is presented on the display. However, image settings are not disclosed. In addition, the display system of US 2005/0195330 is designed for providing individual image content for each viewer, not for providing a single image content for all viewers.

### SUMMARY OF THE INVENTION

It is an object of the present invention to overcome these and other problems of the Prior Art and to provide a device for and method of displaying an image having at least two different image settings so as to allow viewers to enjoy individual image settings while watching the same content.

Accordingly, the present invention provides a device for displaying an image having at least two different image settings, each image setting defining an image reproduction quality, the device comprising:

an image processing unit for providing at least three different partial images, a first pair of partial images together constituting the image having a first image setting and a second pair of partial images together constituting the image having a second image setting, and

a display unit for displaying the at least three partial images,

such that the image having the first image setting and the image having the second image setting are both visible to their respective viewers.

By providing two pairs of partial images, each pair representing a full version of the same image but having individual settings, it is possible for two or more viewers to view the same image while enjoying their individual image settings. By providing at least three different partial images, two pairs of partial images can be formed, as the two pairs may share one partial image. When a partial image is shared between the pairs, the need for a fourth partial image is removed. However, the two pairs may also be formed using four partial images. Of course, three or more pairs of partial images may be used to provide three or more individual settings, using at least four partial images. The partial images of the present invention can be considered phases of the image, which phases are separated by space and/or time.

It is noted that the present invention provides multiple settings for the same image, such that multiple viewers can view said image, each viewer using an individual setting of the shared image. There is not necessarily multiple content (that is, different images) as in split-screen arrangements or in the arrangement of US 2005/0195330 mentioned above. It is further noted that the image may be a still image, such as a photograph, or a moving image, such as a video sequence.

Two pairs of partial images may be displayed separately, thus displaying four partial images, two of which are made available to each viewer. However, according to a further aspect of the present invention, a partial image is preferably shared among the viewers, displaying only three partial images for two viewers. This sharing of a partial image leads to a reduction in the number of partial images required while still providing the advantages of the present invention. Accordingly, a partial image is preferably shared between the at least two image settings, thus allowing an image having two different image settings to be displayed using only three distinct partial images.

In a first embodiment, the display unit comprises display means for displaying the at least three partial images simultaneously. Such means may for example comprise a lenticular or parallax barrier display which projects the partial images at different angles, and consequently at separate spatial locations. In this way, a spatial separation of the partial images is obtained.

In a second embodiment, the display unit comprises means for displaying at least some partial images consecutively, and consequently at separate points in time. In this way, a temporal separation of the partial images is obtained. The display means for displaying at least some partial images consecutively may for example comprise shutters which alternatingly project a partial image.

The image may be two-dimensional but is preferably three-dimensional. When the image is a three-dimensional image, the settings may advantageously comprise depth settings. That is, the present invention allows viewers to have individual depth settings. This is particularly advantageous as different viewers experience image depth differently. As some viewers may feel uncomfortable when viewing a three-dimensional image, in particular a moving image, having a substantial depth effect, the present invention can advantageously be utilized to reduce the amount of depth for these viewers, while leaving the depth setting of other viewers unaltered. One of the viewers may therefore perceive a substantial image depth, while another viewer looking at the same image may perceive a smaller image depth, possibly even a very small image depth.

In addition to, or instead of, settings controlling the overall amount of depth perceived, the depth settings may include depth-of-focus settings controlling the depth range at which (part of) the image is focused, and offset settings controlling the perceived distance of objects in the image from the screen.

It will be understood that the settings available to a particular user may include only a single parameter, for example the overall depth setting. It is preferred, however, to provide more than one setting for each viewer.

The device of the present invention may advantageously further comprise a tracking unit for tracking the position of a viewer, and adjustment means for adjusting at least one partial image in dependence of the position of the viewer. Such a tracking unit is particularly, but not exclusively, advantageous in the case of three-dimensional images, in particular when auto-stereoscopic displays are used. Such displays can be controlled to steer the partial images in the direction of the viewer, thus ensuring that the viewer sees the correct partial images. The adjustment means may automatically adjust partial images in response to the changed position of the viewer.

The device of the present invention may further be provided with at least one control unit which allows the viewers to individually control their settings. This allows manual control of the settings. The control unit may comprise a settings memory for storing favorite settings of viewers.

The device of the present invention may further be provided with at least two pairs of shutter glasses to allow viewers to selectively see consecutively displayed partial images. In an alternative embodiment, the display unit comprises a lenticular display or a parallax display, in which case the shutter glasses may be dispensed with. In still another embodiment, both a display providing spatial separation (such as a lenticular or a parallax display) and means for providing temporal separation (such as shutter glasses) may be used.

The present invention also provides a method of displaying an image having at least two different image settings, each image setting defining an image reproduction quality, the method comprising the steps of:

providing at least three different partial images, a first pair of partial images together constituting the image having a first image setting and a second pair of partial images together constituting the image having a second image setting, and

displaying the at least three partial images,

such that the image having the first image setting and the image having the second image setting are both visible to their respective viewers.

A partial image is preferably shared between the at least two image settings, thus allowing an image having two different image settings to be displayed using only three distinct partial images.

In a first embodiment of the method according to the present invention, the step of displaying comprises displaying the at least three partial images simultaneously, while in a second embodiment the step of displaying comprises displaying at least some partial images consecutively. A third embodiment combines the first and the second embodiments.

The method of the present invention may advantageously comprise the further steps of tracking the position of a viewer, and adjusting at least one partial image in dependence of the position of the viewer.

The image may be a three-dimensional image, in which case the settings may comprise depth settings. Additional embodiments of the method of the present invention will become apparent from the description of the invention given below.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention also provides an image, produced with the device or method defined above.

### BRIEF DESCRIPTION OF THE DRAWINGS

The present invention will further be explained below with reference to exemplary embodiments illustrated in the accompanying drawings, in which:

FIG. 1 schematically shows an embodiment of a device according to the present invention.

FIG. 2 schematically shows a method of sequentially providing partial images according to the present invention.

FIG. 3 schematically shows a method of simultaneously providing partial images according to the present invention.

FIG. 4 schematically shows a consumer device according to the present invention.

### DETAILED DESCRIPTION OF THE EMBODIMENTS

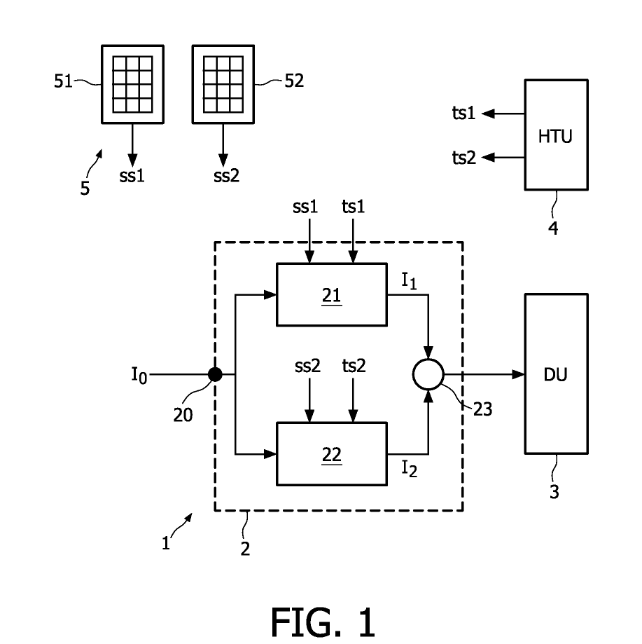

The inventive device 1 shown merely by way of non-limiting example in FIG. 1 comprises an image processing unit 2, a display unit (DU) 3, a head tracking unit (HTU) 4, and a control unit 5. The head-tracking unit 4 is optional and is only used in conjunction with a direction-dependent display unit, such as a display unit having a lenticular display screen. The device 1 receives an input image I₀, which may be a still image, such as a photograph, or a moving image, such as a video sequence.

The image processing unit 2 is arranged for providing at least three different partial images: a first pair of partial images together constituting the image having a first image setting, and a second pair of partial images together constituting the same image but having a second image setting. To this end, the image processing unit 2 of FIG. 1 comprises a first settings unit 21, a second settings unit 22, and a combination unit 23.

The first and second settings units 21 and 22, which are arranged in parallel, each receive the input image I₀ and apply settings, under the control of control unit 5 and/or using predetermined settings. The input image I₀ may include a image data (actual image) and depth data (depth map). Each settings unit applies settings, such as an overall depth setting, a depth-of-focus setting, an offset setting and/or one or more other settings to the image I₀ to produce a pair of partial images which together constitute the original image but to which adjustments may have been made. These adjustments result in images I₁ and I₂ which may have settings that differ from those of the original image I₀. It will be understood that some or all settings of the “adjusted” images I₁ and I₂ may be equal to those of the original image I₀.

In the present example, the settings units 21 and 22 receive settings parameters from the control unit 5. In the embodiment of FIG. 1, the control unit 5 comprises two separate user input units 51 and 52.

The adjusted images I₁ and I₂, which each comprise two partial images, are combined in the combination unit 23 and passed to the display unit 3. This combining of the partial images may involve multiplexing or a similar technique so as to keep the information of the partial images separate, to allow the partial images to be individually rendered by the display unit 3.

The display unit 3 may be a lenticular display, a parallax barrier display or a regular display, and may comprise an LCD (Liquid Crystal Display) screen, a plasma screen, a CRT (Cathode Ray Tube) screen, an electrophoretic display screen, or a passive screen on which images are projected by a suitable projector. Such displays and screens are known per se. The display unit 3 should be capable of projection at least two partial images so as to display a complete image, which preferably is a three-dimensional image. However, it is preferred that the display unit 3 is capable of displaying at least three partial images, simultaneously or substantially simultaneously, such that the image having the first image setting and the image having the second image setting are both visible.

It will be understood that displaying partial images substantially simultaneously involves displaying at least two partial images in rapid succession, such that these images appear to be displayed simultaneously. It is noted that the display unit 3 is designed for providing a single image, and that no split-screen arrangements are necessary to produce the partial images.

In the embodiment shown in FIG. 1, the device 1 is provided with a tracking unit 4 for tracking the position of a viewer. The tracking unit 4, which may be known per se, sends first and second tracking signals Ts1 and Ts2 to the first settings unit 21 and the second settings unit 22 respectively. The settings units 21 and 22 comprise adjustment means for adjusting at least one partial image in dependence of the position of the viewer.

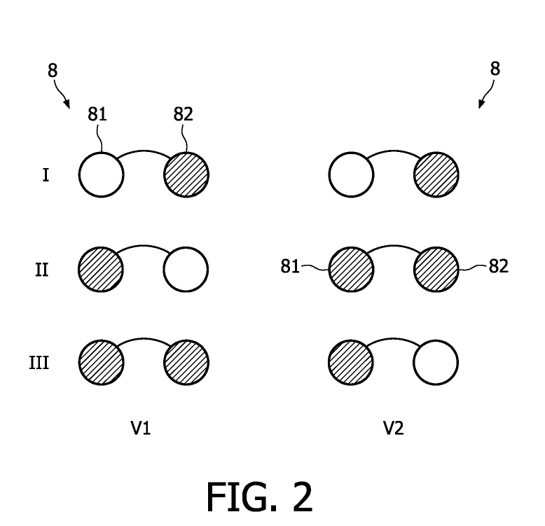

The principle of the present invention is illustrated in FIG. 2. In the embodiment of FIG. 2, shutter glasses are used, which allows the display unit 3 (FIG. 1) to be relatively simple. A pair of shutter glasses 8 is shown to comprise a left glass 81 and a right glass 82, which can be controlled independently. Each glass has a transparent and an opaque state, which can be controlled by the device 1. For example, an infrared signal transmitted by the signal processing unit 2 (FIG. 1) may control the glasses 81 and 82. It is noted that shutter glasses are known per se, and may for example comprise glasses having a controlled polarization.

In the example of FIG. 2, three different phases I, II and III are shown for two viewers V1 and V2, each viewer wearing a pair of shutter glasses 8. In each of the three phases of FIG. 2, a different partial image is shown, each partial image representing the contribution of a single eye to the entire image.

In the first phase I, the left glass 81 of both viewer V1 and viewer V2 is transparent, the right glass being opaque. Consequently, both viewers see a first partial image with their left eye (left partial image L). In the second phase II, the first viewer V1 sees a second partial image with her right eye (right partial image R1) as the left glass 81 of her glasses is opaque while the right glass 82 is transparent. At the same time, the second viewer V2 temporarily sees no (partial) image at all as both glasses are opaque. In the third phase III, both glasses of the first viewer V1 are opaque. At the same time, the left glass of the second viewer V2 is opaque while her right glass is transparent, allowing her to see a third partial image (additional right image R2).

According to the present invention, the second partial image (in the present example the right image R1) and the third partial image (in the present example the additional right image R2) may be different, allowing the viewers V1 and V2 to experience different images. For example, the first and second partial images (L and R1) may together constitute a three-dimensional image having a large depth, while the first and third partial images (L and R2) may together constitute the same three-dimensional image but having a reduced depth.

The shutter glasses 8 step through the three phases I, II and III quickly, each phase lasting, for example, approximately 10 or 20 ms. After phase III, the shutter glasses return to phase I to repeat the process, giving the viewers the impression of continuous images.

Accordingly, in the example of FIG. 2, each phase presents a distinct partial image to at least one viewer. The left image L of the first phase is shared between the viewers, while in both other phases only one of the viewers is able to see a partial image. It will be understood that the “shared” phase, in the present example the first phase I, may instead present a shared right image R, while distinct partial images L1 and L2 are presented in the two remaining phases.

In accordance with the present invention, two versions of the same image (that is, an image having two distinct sets of settings) can also be produced using four phases instead of three, for example using two left partial images L1 and L2, and two right partial images R1 and R2. However, using only three phases (and three corresponding partial images) reduces the “blanking” of the image, as occurs in the present example during the second phase II for the second viewer V2, and therefore improves the light efficiency. In addition, producing three instead of four phases is technically less complex while maintaining the advantages of the multiple phases.

It will be understood that the principle of the present invention can readily be expanded to three or more viewers using at least four phases and, for example, partial images L, R1, R2 and R3.

In the example of FIG. 2 it has been assumed that the image is a three-dimensional image, thus requiring two different partial images for each user.

In the embodiment of FIG. 2, shutter glasses are used to selectively view partial images which are sequentially displayed. This embodiment has the advantage that the display device can be relatively simple, a conventional television display screen or computer monitor may be used for this purpose. However, some viewers prefer not to wear shutter glasses, in which case other display devices must be used.

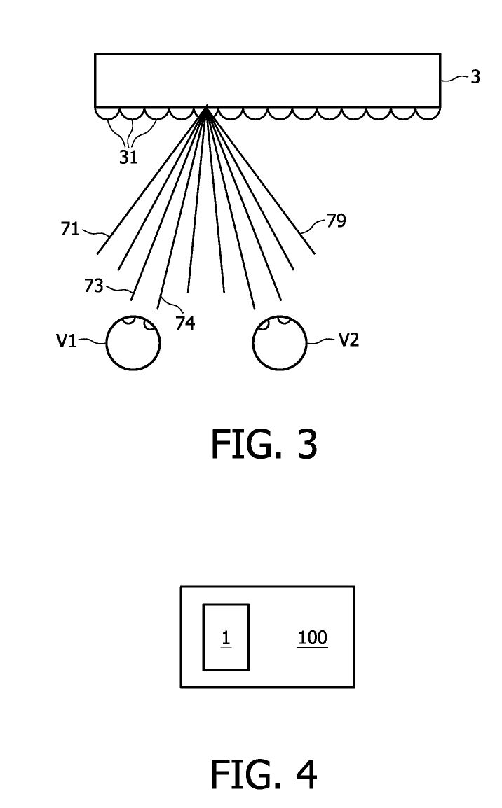

A lenticular display device 3 is schematically illustrated in FIG. 3. In the exemplary embodiment of FIG. 3, the side of the display device facing the viewers 91 and 92 is provided with substantially cylindrical lenses 31, behind which display screen pixels (not shown) are arranged. In a manner known per se, each lens produces a plurality of image projection positions 71-79.

In the embodiment shown in FIG. 3, the positions 71-74 produce the image having a first set of settings, while the positions 75-79 produce the same image having a second set of settings. To this end, the positions 71-74 provide a first pair of partial images (e.g. L and R1), preferably alternatingly (e.g. L, R1, L, R1), such that the viewer V1 sees a complete pair of partial images (L, R1) when her eyes are located at the (angular) positions 73 and 74. Similarly, each pair of positions 75-79 provides an alternative pair of partial images (e.g. L and R2). That is, to each pair of positions 71-74 a first (L) and second (R1) partial image are displayed, while to each pair of positions 75-79 the first (L) and a third (R2) partial image are displayed. In this way, the same effect can be obtained as in the embodiment of FIG. 2: the first and second partial images provide the image having a first setting (or set of settings), while the first and third partial images provide the same image having a second setting (or set of settings). Of course, as noted with reference to FIG. 2, it is possible not to share the first (or second) partial image, and to provide four separate partial images L1, L2, R1 and R2.

The angles at which the partial images are projected by the display unit 3 may either be fixed or variable. It is preferred to use a variable display unit combined with a head tracking unit (4 in FIG. 3) to ensure that a viewer sees the correct pair of partial images.

It is noted that the phases mentioned with reference to the embodiment of FIG. 2 are temporal phases (partial images displayed at different points in time), while in the embodiment of FIG. 3 the phases are spatial phases (partial images displayed at different points in space). Embodiments can be envisaged in which the phases are separated by both time and space.

Instead of, or in addition to the shutter glasses arrangement of FIG. 2 and the lenticular (autostereoscopic) display arrangement of FIG. 3, other arrangements according to the present invention are possible. For example, the lenticular display of FIG. 3 may be replaced with a parallax barrier display, which may be known per se. A volumetric display using, for example, a rotating helix screen or a rotating LED array screen (with optics on top of the rotating LED array directing their light predominantly orthogonal to the instantaneous LED plane), may also be utilized. Those skilled in the art will understand that various display types may be used (e.g. narrow light beams scanning across rotating part of an ellipsoidal specular reflector), and that the shutter glasses mentioned above may be replaced or complemented with other arrangements which allow a temporal separation of the partial images (e.g. spectral separation).

In the above discussion it has been assumed that both or all viewers see the same image (single content). In the case of multiple content, where two or more different images are being displayed substantially simultaneously, the present invention can also be applied by allowing the viewers of a particular image (or sequence of images) to enjoy their personal image settings. If two distinct images are essentially simultaneously displayed, for example, each image may involve three or more partial images, thus resulting in at least six partial images being displayed.

The present invention may be utilized in, for example, television and home video systems, computer display apparatus, cinemas, and/or portable consumer devices such as mobile telephones, PDAs (Personal Digital Assistants) and electronic game devices (such as game consoles), professional environments, such as teaching, medical, . . . .

FIG. 4 schematically illustrates an apparatus 100 comprising a device 1 according to the present invention. The present invention may also be utilized in medical apparatus, for example in surgical monitoring apparatus.

The present invention may be summarized as a device for and a method of displaying an image having at least two different image settings, comprising the steps of providing at least three different partial images, and displaying the at least three partial images. A first and second pair of partial images constitute the image having a first image setting and the same image having a second image setting respectively, such that the image having both image settings is visible. The partial images may be displayed either simultaneously or consecutively. The settings may comprise various depth settings, such as overall (perceived) depth, depth-of-focus, and offset.

The present invention is based upon the insight that by providing two or more partial images which together constitute a complete image, and by selectively displaying those partial images, multiple users can view individual versions of the same image. The present invention benefits from the further insight that varying only one partial image is sufficient to provide two versions of the complete image.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (1) for displaying an image having at least two different image settings, each image setting defining an image reproduction quality, the device comprising:
an image processing unit (2) for providing at least three different partial images, a first pair of partial images together constituting the image having a first image setting and a second pair of partial images together constituting the image having a second image setting, and
a display unit (3) for displaying the at least three partial images,
such that the image having the first image setting and the image having the second image setting are both visible to their respective viewers (V1, V2).

2. The device according to claim 1, wherein a partial image is shared between the at least two image settings.

3. The device according to claim 1, wherein the display unit (3) comprises means for displaying the at least three partial images simultaneously.

4. The device according to claim 3, wherein the display unit (3) comprises a lenticular display or a parallax barrier display.

5. The device according to claim 1, wherein the display unit (3) comprises means for displaying at least some partial images consecutively.

6. The device according to claim 1, further comprising a tracking unit (4) for tracking the position of a viewer (V1; V2), wherein the image processing unit (2) comprises adjustment means for adjusting at least one partial image in dependence of the position of the viewer.

7. The device according to claim 1, wherein the image is a three-dimensional image and the settings comprise depth settings.

8. The device according to claim 7, wherein the depth settings comprise overall depth, depth-of-focus and/or offset settings.

9. The device according to claim 1, further comprising at least one control unit (5) which allows the viewers (V1, V2) to individually control their settings.

10. The device according to claim 1, further comprising at least two pairs of shutter glasses (8).

11. An image processing unit (2) for use in the device according to claim 1.

12. A consumer device (100), such as a television apparatus or a mobile telephone apparatus, comprising a device (1) for displaying an image having at least two different image settings, each image setting defining an image reproduction quality, the device comprising:
an image processing unit (2) for providing at least three different partial images, a first pair of partial images together constituting the image having a first image setting and a second pair of partial images together constituting the image having a second image setting, and
a display unit (3) for displaying the at least three partial images,
such that the image having the first image setting and the image having the second image setting are both visible to their respective viewers (V1, V2) or an image processing unit (2) according to claim 11.

13. A method of displaying an image having at least two different image settings, each image setting defining an image reproduction quality, the method comprising the steps of:
providing at least three different partial images, a first pair of partial images together constituting the image having a first image setting and a second pair of partial images together constituting the image having a second image setting, and
displaying the at least three partial images,
such that the image having the first image setting and the image having the second image setting are both visible to their respective viewers (V1, V2).

14. The method according to claim 13, wherein a partial image is shared between the at least two image settings.

15. The method according to claim 13, wherein the step of displaying comprises displaying the at least three partial images simultaneously.

16. The method according to claim 13, wherein the step of displaying comprises displaying at least some partial images consecutively.

17. The method according to claim 13, comprising the further steps of:
tracking the position of a viewer (V1; V2), and
adjusting at least one partial image in dependence of the position of the viewer.

18. The method according to claim 13, wherein the image is a three-dimensional image and the settings comprise depth settings.

19. The method according to claim 18, wherein the depth settings comprise overall depth, depth-of-focus and/or offset settings.

20. A computer program product for carrying out the method according to claim 13.

21. An image, in particular a three-dimensional image, produced using the method according to claim 13.
